(19) United States
(12) Patent Application Publication
(10) Pub. No.: US 2025/0269855 A1
(43) Pub. Date: Aug. 28, 2025

(54) VEHICLE CONTROL DEVICE, CONTROL METHOD, AND STORAGE MEDIUM

(71) Applicant: TOYOTA JIDOSHA KABUSHIKI KAISHA, Toyota-shi (JP)

(72) Inventor: Kazuaki ASO, Gotemba-shi (JP)

(73) Assignee: TOYOTA JIDOSHA KABUSHIKI KAISHA, Toyota-shi (JP)

(21) Appl. No.: 18/971,715

(22) Filed: Dec. 6, 2024

(30) Foreign Application Priority Data
Feb. 26, 2024 (JP) 2024-026232

(51) Int. Cl. B60W 30/18

(52) U.S. Cl. CPC B60W 30/18163; B60W 2540/18; B60W 2552/10

(57) ABSTRACT

A control device for a vehicle that performs lane change control for automatically changing a lane from a target lane to a target lane by causing the vehicle to travel along a set target trajectory includes a correction processing unit that performs correction processing for moving the target trajectory forward or backward such that, when a lateral position of the vehicle deviates from the target trajectory due to a steering operation of a driver of the vehicle during execution of lane change control, the target lateral position of the target trajectory approaches a current lateral position of the vehicle.

### CROSS-REFERENCE TO RELATED APPLICATION

This application claims priority to Japanese Patent Application No. 2024-026232 filed on Feb. 26, 2024, incorporated herein by reference in its entirety.

### BACKGROUND

### 1. Technical Field

The present disclosure relates to a vehicle control device, a control method, and a storage medium.

### 2. Description of Related Art

There is known a vehicle control device that executes lane change control (Lane Change Assist: LCA) for automatically changing lanes from a lane where the vehicle is traveling to an adjacent target lane. For example, Japanese Unexamined Patent Application Publication No. 2018-92538 (JP 2018-92538 A) discloses a technology in which LCA is continued when a stop condition is not satisfied while a driver intervenes in steering in the same direction as the steering direction of the LCA during execution of the LCA, and the driver is notified about termination of the LCA when the stop condition is satisfied.

### SUMMARY

When the lateral position of the vehicle deviates from a target trajectory (target lateral position) of the LCA due to the driver's steering intervention during the LCA, the control device attempts to return the lateral position of the vehicle to the target trajectory by applying a steering torque to the vehicle in a direction opposite to that of the steering operation of the driver. Therefore, there is a problem that the driver feels discomfort or inconvenience because a feeling of interference occurs in the steering operation of the driver (the steering torque in the direction opposite to that of the steering input is transmitted to the driver) or the behavior caused by the lane change of the vehicle is a behavior that causes a feeling different from the feeling of the driver.

The technology of the present disclosure has been made to solve the above problem, and an object thereof is to realize smooth lane change even when a lateral position of a vehicle deviates from a target trajectory of LCA.

A device of the present disclosure is a vehicle control device configured to execute lane change control for automatically changing lanes from a lane where a vehicle is traveling to a target lane adjacent to the lane by causing the vehicle to travel along a set target trajectory.

The vehicle control device includes a correction processing unit configured to, when a lateral position of the vehicle deviates from the target trajectory due to a steering operation of a driver of the vehicle during execution of the lane change control, execute a correction process for moving the target trajectory forward or backward to bring a target lateral position of the target trajectory closer to a current lateral position of the vehicle.

A method of the present disclosure is a vehicle control method for executing lane change control for automatically changing lanes from a lane where a vehicle is traveling to a target lane adjacent to the lane by causing the vehicle to travel along a set target trajectory.

The vehicle control method includes executing, when a lateral position of the vehicle deviates from the target trajectory due to a steering operation of a driver of the vehicle during execution of the lane change control, a correction process for moving the target trajectory forward or backward to bring a target lateral position of the target trajectory closer to a current lateral position of the vehicle.

A storage medium of the present disclosure stores a program that causes a computer of a vehicle control device to execute a correction process. The vehicle control device is configured to execute lane change control for automatically changing lanes from a lane where a vehicle is traveling to a target lane adjacent to the lane by causing the vehicle to travel along a set target trajectory.

The correction process is a process of, when a lateral position of the vehicle deviates from the target trajectory due to a steering operation of a driver of the vehicle during execution of the lane change control, moving the target trajectory forward or backward to bring a target lateral position of the target trajectory closer to a current lateral position of the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating a hardware configuration of a vehicle according to the present embodiment;

FIG. 2 is a schematic diagram illustrating a software configuration of the control device according to the present embodiment;

FIG. 3 is a schematic diagram illustrating an exemplary target trajectory of an LCA;

FIG. 4A is a schematic diagram illustrating a correcting process performed by a control device according to the present embodiment;

FIG. 4B is a schematic diagram illustrating a correcting process performed by a control device according to the present embodiment;

FIG. 4C is a schematic diagram illustrating a correcting process performed by a control device according to the present embodiment;

FIG. 4D is a schematic diagram illustrating a correcting process performed by a control device according to the present embodiment;

FIG. 5A is a schematic diagram illustrating a correcting process performed by a control device according to the present embodiment;

FIG. 5B is a schematic diagram illustrating a correcting process performed by a control device according to the present embodiment;

FIG. 5C is a schematic diagram illustrating a correcting process performed by a control device according to the present embodiment;

FIG. 5D is a schematic diagram illustrating a correcting process performed by a control device according to the present embodiment; and

FIG. 6 is a flowchart illustrating a routine of correction processing performed by the control device according to the present embodiment.

### DETAILED DESCRIPTION OF EMBODIMENTS

Hereinafter, a control device, a control method, and a program of a vehicle according to the present embodiment will be described with reference to the drawings.

### Hardware Configuration

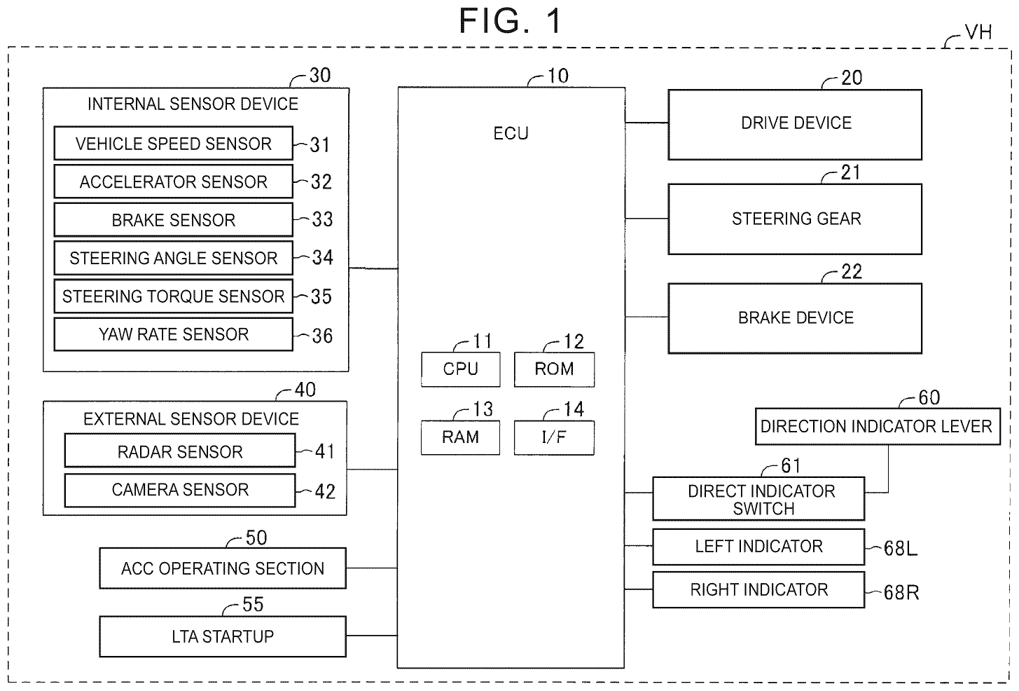

FIG. 1 is a schematic diagram illustrating a hardware configuration of a vehicle VH to which a control device according to the present embodiment is applied. In the following description, the vehicle VH may be referred to as an own vehicle when it needs to be distinguished from other vehicles or the like.

The vehicle VH has ECU (Electronic Control Unit) 10. ECU 10 includes CPU (Central Processing Unit) 11, ROM (Read Only Memory) 12, RAM (Random Access Memory) 13, and interface device 14. CPU 11 is a processor that executes various programs stored in ROM 12. ROM 12 is a non-volatile memory that stores data and the like required for CPU 11 to execute various programs. RAM 13 provides a working area to be deployed when various programs are executed by CPU 11. Each of ROM 12 and RAM 13 is an example of a storage medium. The interface device 14 is a communication device for communicating with an external device.

ECU 10 is a central device that performs driving support control such as LCA, tracking inter-vehicle distance control (Adaptive Cruise Control: ACC), lane keeping support control (Lane Trace Assist: LTA), and the like. Driving assistance control is a concept including automatic driving control. To ECU 10, a drive device 20, a steering device 21, a braking device 22, an internal sensor device 30, an external sensor device 40, an ACC operating unit 50, a LTA activation switch 55, a direction indicator switch 61, a direction indicator 68L, 68R, and the like are communicably connected.

The drive device 20 generates a driving force to be transmitted to the driving wheels of the vehicle VH. Examples of the drive device 20 include an electric motor and an engine. In the present embodiment, the vehicle VH may be any of a hybrid electric vehicle (HEV), a plug-in Hybrid vehicle (PHEV), a fuel cell electric vehicle (FCEV), a battery electric vehicle (BEV), and an engine-driven vehicle. The steering device 21 applies a steering force to the wheels of the vehicle VH. The braking device 22 applies a braking force to the wheels of the vehicle VH.

The internal sensor device 30 is a sensor for detecting the condition of VH. Specifically, the internal sensor device 30 includes a vehicle speed sensor 31, an accelerator sensor 32, a brake sensor 33, a steering angle sensor 34, a steering torque sensor 35, a yaw rate sensor 36, and the like.

The vehicle speed sensor 31 detects a traveling speed (hereinafter, vehicle speed v) of the vehicle VH. The accelerator sensor 32 detects an operation amount of an accelerator pedal (not shown) by a driver. The brake sensor 33 detects an operation amount of a brake pedal (not shown) by the driver. The steering angle sensor 34 detects a rotational angle of a steering wheel or a steering shaft (not shown) of the vehicle VH, that is, a steering angle. The steering torque sensor 35 detects the rotational torque of the steering wheel or the steering shaft, that is, the steering torque. The yaw rate sensor 36 detects a yaw rate of the vehicle VH. The internal sensor device 30 transmits the condition of the vehicle VH detected by the sensors 31 to 36 to ECU 10 at a predetermined cycle.

The external sensor device 40 is a sensor or the like that recognizes target information related to a target in the vicinity of VH. Specifically, the external sensor device 40 includes a radar sensor 41, a camera sensor 42, and the like. Examples of the target information include a surrounding vehicle, a pedestrian, a traffic light, a white line of a road, a sign, and a falling object.

The radar sensor 41 detects a target that is present around the vehicle VH. The radar sensor 41 includes a millimeter wave radar and/or a lidar. The millimeter wave radar emits a millimeter wave and receives a millimeter wave (reflected wave) reflected by a target object existing in a radiation range. The millimeter wave radar acquires the relative distance between the vehicle VH and the target, the relative velocity between the vehicle VH and the target, and the like based on the phase difference between the transmitted millimeter wave and the received reflected wave, the attenuation level of the reflected wave, the time from the transmission of the millimeter wave until the reception of the reflected wave, and the like. The lidar sequentially scans pulsed laser beams having a shorter wavelength than millimeter waves toward a plurality of directions, and receives the reflected light reflected by the targets, thereby obtaining shapes of the targets detected in front of the vehicle VH, relative distances between the vehicle VH and the targets, relative velocities between the vehicle VH and the targets, and the like.

The camera sensor 42 captures an image of the surroundings of the vehicle VH and processes the captured image-data to acquire target object information around the vehicle VH. As the camera sensor 42, for example, a digital camera having an image sensor such as a CMOS or a CCD can be used. The target information is information indicating a type of a target detected around the vehicle VH, a relative distance between the vehicle VH and the target, a relative velocity between the vehicle VH and the target, and the like. The type of the target may be recognized by machine learning such as pattern matching, for example.

The external sensor device 40 repeatedly transmits the acquired target object data to ECU 10 every time a predetermined period elapses. ECU 10 determines the relative relationship between the vehicle VH and the target by synthesizing the relative relationship between the vehicle VH and the target obtained by the radar sensor 41 and the relative relationship between the vehicle VH and the target obtained by the camera sensor 42. Note that the external sensor device 40 does not necessarily have to include both the radar sensor 41 and the camera sensor 42, and may include, for example, only the radar sensor 41 or only the camera sensor 42.

The ACC operating unit 50 includes, for example, a start switch for selecting whether the driver activates or terminates ACC, a setting switch for setting the target vehicle speed and the target inter-vehicle distance of ACC, a cancel switch for temporarily canceling ACC, a resume switch for resuming ACC, and the like. LTA activation switch 55 is a ON/OFF switch for selecting whether the drivers activate or terminate LTA.

The direction indicator lever 60 is an operating device for causing the drivers to blink the left and right direction indicator 68L,68R. The direction indicator switch 61 detects an operation direction of the direction indicator lever 60 by the driver. When the driver operates the direction indicator lever 60 by a predetermined amount (for example, deep), the direction indicator switch 61 transmits a blinking instruction signal corresponding to the operation direction to ECU 10. When ECU 10 receives the blinking instruction signal, it causes the direction indicator 68L,68R corresponding to the operating direction of the direction indicator lever 60 to blink.

The direction indicator lever 60 is also used as an operating device that requires the driver to change the lane by LCA. Specifically, when the driver operates and holds the direction indicator lever 60 by a predetermined amount (e.g., shallow), the direction indicator switch 61 transmits, to ECU 10, a LCA request signal indicating that the driver is requesting a lane change to a neighboring lane (target lane) in the operation direction of the direction indicator lever 60, together with a blink instruction signal corresponding to the operation direction.

### Software Configuration

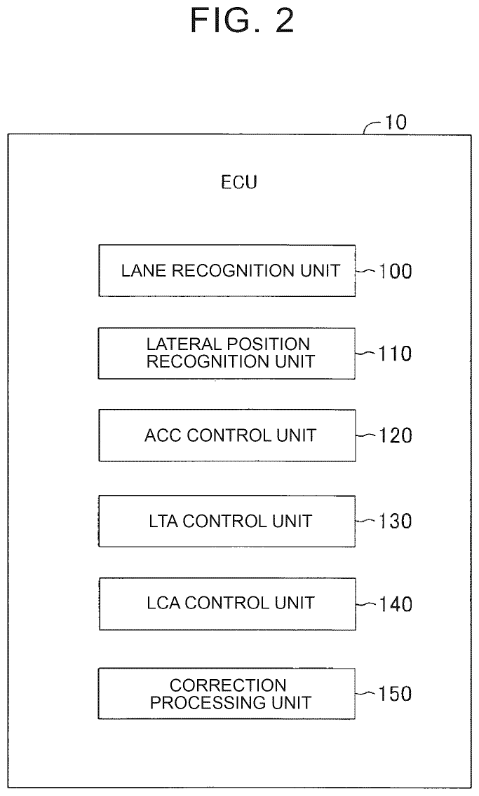

FIG. 2 is a schematic diagram illustrating a software configuration of ECU 10 according to the present embodiment. As illustrated in FIG. 2, ECU 10 includes a lane recognition unit 100, a lateral position recognition unit 110, an ACC control unit 120, an LTA control unit 130, a LCA control unit 140, a correction processing unit 150, and the like as functional elements. These functional elements 100 to 150 are realized by CPU 11 of ECU 10 reading a program stored in ROM 12 into a RAM 13 and executing the program. Note that all or a part of the functional elements 100 to 150 may be provided in another ECU separate from ECU 10 or in an information processing device of a facility (e.g., a control center) capable of communicating with the vehicle VH.

The lane recognition unit 100 recognizes a lane (hereinafter, referred to as a traveling lane) in which the vehicle VH is traveling. The lane recognition unit 100 recognizes the border line of the traveling lane, for example, on the basis of images or the like of the surroundings of the vehicle VH acquired by the external sensor device 40. Here, the boundary lines include not only white lines and yellow lines drawn on the road surface, but also curbstones, guardrails, and the like. The lane recognition unit 100 recognizes the traveling lane based on the recognized boundary line.

The lateral position recognition unit 110 recognizes the lateral position of the vehicle VH based on the detection result of the external sensor device 40. Here, the lateral position of the vehicle VH refers to a lane-width-direction position of the host vehicle VH in the traveling lane. The lateral position recognition unit 110 recognizes the lateral position of the vehicle VH in the traveling lane based on the position of the vehicle VH with respect to the borderline of the traveling lane recognized by the lane recognition unit 100.

The ACC control unit 120 executes ACC based on the target vehicle speed or the target inter-vehicle distance. Since ACC is known per se, it will be briefly described below. ACC includes two types of control: constant speed travel control and follow-up travel control. The constant speed travel control is a control for causing the vehicle VH to travel at a constant speed according to the target vehicle speed. The following travel control is a control for causing the preceding vehicle to follow the own vehicle VH such that the actual inter-vehicle distance between the preceding vehicle traveling in the traveling lane and the own vehicle VH becomes the target inter-vehicle distance.

When the activation of ACC operating unit 50 is switched ON, ACC control unit 120 detects the following target vehicle (preceding vehicle) to be followed in the traveling lane recognized by the lane recognition unit 100 based on the detection result of the external sensor device 40. ACC control unit 120 executes constant speed travel control when the following target vehicles do not exist. Here, ACC control unit 120 controls the operation of the drive device 20 and the braking device 22 based on the target acceleration obtained from the deviation between the vehicle speed v and the target vehicle speed detected by the vehicle speed sensor 31. On the other hand, ACC control unit 120 executes the following travel control when the following target vehicles exist in the traveling lane. In this situation, ACC control unit 120 controls the operation of the drive device 20 and the braking device 22 based on the target acceleration obtained from the deviation between the actual inter-vehicle distance and the target inter-vehicle distance. The actual inter-vehicle distance between the own vehicle VH and the tracking target vehicle may be recognized based on the detection result of the external sensor device 40.

LTA control unit 130 executes LTA control for automatically changing the steering angle (turning angle of steered wheels) so that the lateral position of the vehicle VH is maintained at the target lateral position in the traveling lane during the operation of ACC. Since LTA is known per se, it will be briefly described below. When LTA activation switch 55 is turned ON while the ACC control unit 120 performs ACC, LTA control unit 130 sets the target lateral position of the vehicle VH based on the border line of the traveling lane recognized by the lane recognition unit 100. The target lateral position is set, for example, near the center of the traveling lane in the lane width direction. LTA control unit 130 changes the steering angle of the host vehicle VH by controlling the operation of the steering device 21 so that the lateral position of the vehicle VH recognized by the lateral position recognition unit 110 is maintained near the target lateral position in the traveling lane.

LCA control unit 140 executes a LCA of controlling the operation of the drive device 20, the steering device 21, and the braking device 22 so as to move from the traveling lane in which the vehicle VH is currently traveling to the lane (target lane) adjoining the traveling lane, and assisting the steering operation of the drivers. Since LCA is known per se, it will be briefly described below. LCA is implemented on behalf of LTA in the same manner as LTA, which controls the lateral position of the vehicle VH and receives support requests from drivers during LTA and ACC implementation. For example, LCA control unit 140 executes LCA when the following execution permission condition is satisfied.
(1) A LCA demand is received from the direction indicator switch 61.
(2) ACC start switch and LTA start switch 55 are turned ON.
(3) The white line that forms the boundary between the traveling lane and the target lane shall be a broken line.
(4) The external sensor device 40 does not detect an obstacle such as another vehicle that obstructs lane change in the target lane.
(5) Vehicle speed v of the vehicle VH is within the specified allowable speed range.
   Note that the execution permission conditions (1) to (5) are examples, and may not include some conditions, or may further include other conditions (for example, a type of a road such as an automobile dedicated road).

When at least the execution permission condition (1) is satisfied, that is, when LCA request-signal is received, LCA control unit 140 starts blinking the direction-indicator 68L, 68R on the target lane-side. In addition, LCA control unit 140 determines that the condition for starting the lane change (lateral movement) is satisfied when a predetermined waiting time Tv has elapsed since the execution permission condition (1) to (5) is satisfied.

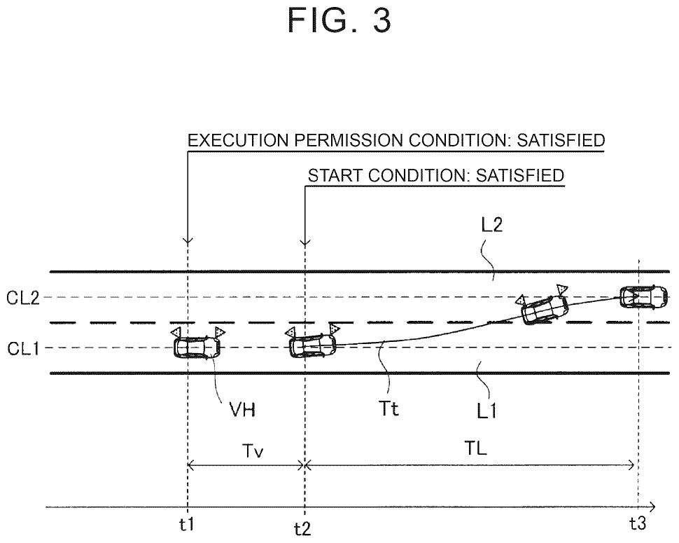

LCA control unit 140 calculates a target trajectory that determines a target trajectory of the vehicle VH. The target trajectory Tt is, for example, a shape as shown in FIG. 3, and is a trajectory for moving the host vehicle VH from the traveling lane L1 to the widthwise center position CL2 (hereinafter, the final target lateral position) of the target lane L2 over the target lane change period TL. Note that t2 from the time t1 in FIG. 3 indicates the time from the establishment of the execution permission condition (1) to the elapse of the waiting time Tv (5). The target trajectory function is a function for calculating the target lateral position y, the target lateral speed vy, and the target lateral acceleration ay of the vehicle VH corresponding to the elapsed time from the start point of the lane change (that is, the time t2 at which the start point of the lane change is satisfied) with reference to the lane center line CL1 of the traveling lane L1. The target lane change time LT is set based on a target lateral distance required to laterally move the vehicle VH from the starting position of the lane change to the final target lateral position CL2.

LCA control unit 140 calculates the target lateral position y, the target lateral velocity vy, and the target lateral acceleration ay at the current time point on the basis of the target trajectory function and the elapsed time when the lane change starting condition is satisfied at the time t2 with the lapse of the waiting time Tv. Further, LCA control unit 140 calculates the target yaw angle θy, the target yaw rate γ, and the target curvature Cu at the current time point based on the vehicle speed v, the target lateral speed vy, and the target lateral acceleration ay at the current time point, and calculates the target steering angle θ based on the target lateral position y, the target yaw angle θy, the target yaw rate γ, and the target curvature Cu. Then, LCA control unit 140 controls the operation of the drive device 20, the steering device 21, and the braking device 22 based on the target lateral velocity vy, the target lateral acceleration ay, and the target steering angle θ, thereby laterally moving the vehicle VH toward the final target lateral position CL2. LCA control unit 140 terminates LCA when the vehicle VH reaches the final target lateral position CL2 of the target lane L2, as shown by time t3 in FIG. 3.

When the following cancellation conditions (1) to (5) are satisfied during execution of LCA, LCA control unit 140 aborts LCA being executed.
(1) An input (steering intervention) of a steering torque equal to or higher than a predetermined threshold value by a steering operation of the driver is detected (override).
(2) Brake operation by the driver is detected.
(3) When LCA is deactivated by operating the direction indicator lever 60.
(4) The white line, which is the boundary between the running lane and the target lane, is no longer a broken line.
(5) The other vehicles traveling on the target lane approach the host vehicle VH, and it is impossible to secure a safe distance between vehicles.
   When at least one of the cancellation conditions (1) to (5) is satisfied, LCA control unit 140 aborts LCA being executed. The input of the steering torque (steering intervention) may be acquired based on the detection result of the steering torque sensor 35, and the braking operation of the driver may be acquired based on the detection result of the brake sensor 33.

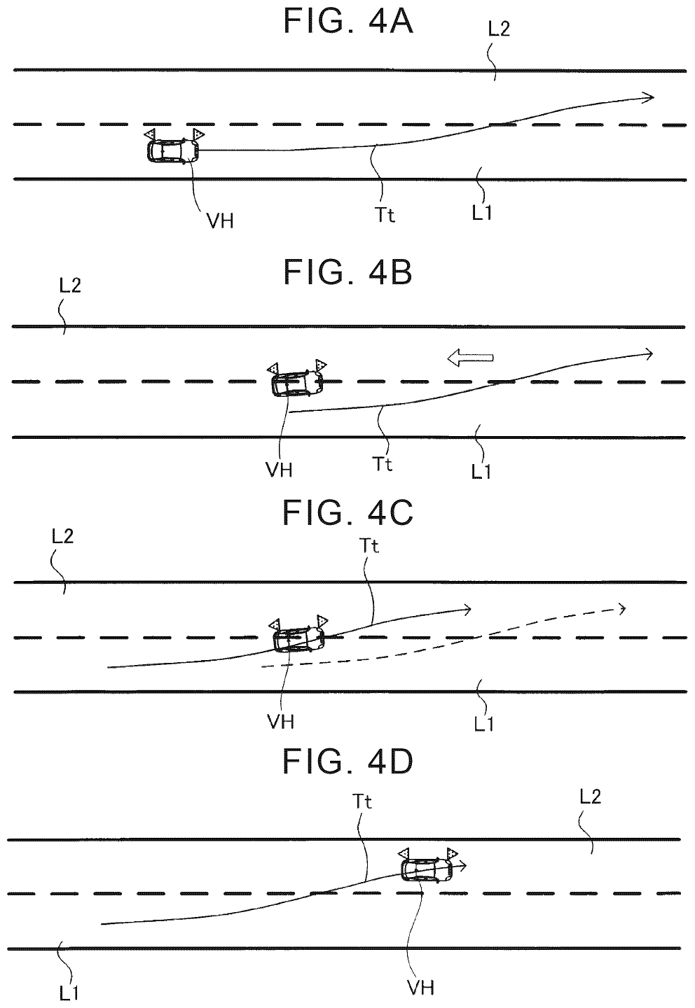

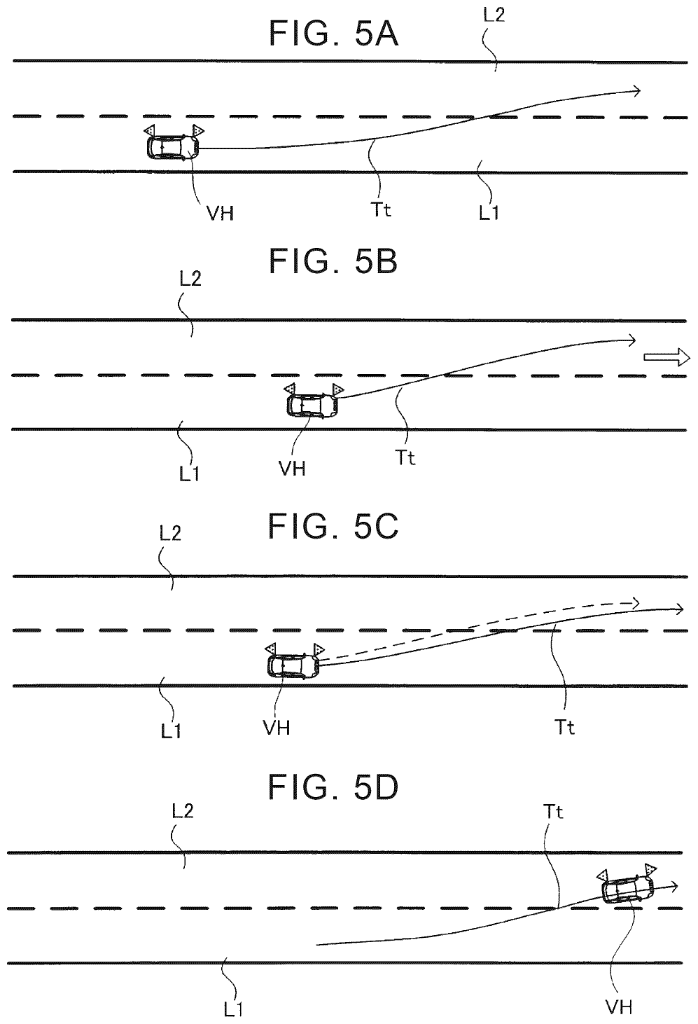

When the driver performs the steering operation while LCA is being executed, the lateral position of the vehicle VH may deviate from the target trajectory Tt of LCA even when the steering torque inputted by the steering operation is less than the predetermined threshold (that is, when the cancellation condition (1) is not satisfied). When such a deviation occurs, if the lateral position of the vehicle VH is to be returned to the target trajectory Tt, the driver's steering maneuver may feel dangerous, or the behavior of the vehicle VH due to the lane change may behave differently from the feeling of the driver, so that the continuity of the control may be lost. That is, the loss of continuity of the control may cause troublesomeness or discomfort to the driver. When a deviation occurs between the lateral position of the vehicle VH and the target trajectory Tt due to the steering intervention of the driver during LCA, the correction processing unit 150 changes the present time (elapsed time from the start of control) of the vehicle VH with respect to the target lane change time LT. As a result, the correction processing unit 150 executes correction processing for maintaining the continuity of the control. Hereinafter, the correction processing executed by the correction processing unit 150 according to the present embodiment will be described with reference to FIGS. 4A to 4D and FIGS. 5A to 5D.

### Correction Processing

FIGS. 4A to 4D are each a schematic diagram illustrating a correcting process when the driver performs a steering operation on the target lane L2 and the lateral position of the vehicle VH with respect to the target trajectory Tt is shifted toward the target lane L2. When the driver's steering intervention is detected based on the detection result of the steering torque sensor 35, the correction processing unit 150 determines whether or not the lateral position of the vehicle VH is deviated from the target trajectory Tt based on the recognition result of the lateral position recognition unit 110. As shown in FIG. 4B, when the lateral position of the vehicle VH is shifted with respect to the target trajectory Tt toward the target lane L2, the correction processing unit 150 advances the present time of the vehicle VH with respect to the target lane change time LT. Accordingly, the correction processing unit 150 slides the target trajectory Tt backward toward the vehicle VH.

Thus, as shown in FIG. 4C, the present lateral position of the vehicle VH coincides with the target trajectory Tt (target lateral position y) at the present time. After the lateral position of the vehicle VH coincides with the target lateral position y, as shown in FIG. 4D, LCA control unit 140 moves the vehicle VH laterally along the target trajectory Tt again, thereby continuing LCA. That is, the continuity of LCA control can be maintained only by sliding the target trajectory Tt backward (advancing the time) without changing the shape of the target trajectory Tt. Thus, even when the lateral position of the vehicle VH deviates from the target trajectory Tt toward the target lane L2, a smooth LCA can be realized without giving a sense of discomfort to the driver in the steering operation or the behavior of the vehicle VH due to the lane change.

FIGS. 5A to 5D are each a schematic diagram illustrating a correcting process when the lateral position of the vehicle VH with respect to the target trajectory Tt deviates from the target lane L2 due to a steering intervention (e.g., a steering operation for holding the steering wheel) by the driver. When the driver's steering intervention is detected based on the detection result of the steering torque sensor 35, the correction processing unit 150 determines whether or not the lateral position of the vehicle VH is deviated from the target trajectory Tt based on the recognition result of the lateral position recognition unit 110. As shown in FIG. 5B, when the lateral position of the vehicle VH is shifted from the target trajectory Tt to the other side from the target lane L2, the correction processing unit 150 delays the present time of the vehicle VH with respect to the target lane change time LT. Accordingly, the correction processing unit 150 slides the target trajectory Tt forward and away from the vehicle VH.

Thus, as shown in FIG. 5C, the present lateral position of the vehicle VH coincides with the target trajectory Tt (target lateral position y) at the present time. After the lateral position of the vehicle VH coincides with the target lateral position y, as shown in FIG. 5D, LCA control unit 140 moves the vehicle VH laterally along the target trajectory Tt again, thereby continuing LCA. That is, the continuity of LCA control can be maintained only by sliding the target trajectory Tt forward (delaying the time) without changing the shape of the target trajectory Tt. Accordingly, even when the lateral position of the vehicle VH deviates from the target trajectory Tt to the other side from the target lane L2, the driver can realize a smooth LCA without giving a sense of discomfort to the vehicle VH behavior due to the feeling of a danger of the steering operation and the lane change.

In any of the cases shown in FIGS. 4A to 4D, and FIGS. 5A to 5D, the method of making the lateral position of the vehicle VH coincide with the target lateral position y may be adjusted stepwise by repeatedly advancing or delaying the present time of the vehicle VH for a predetermined period until the lateral position of the vehicle VH coincides with the target lateral position y. Alternatively, the time required to make the lateral position of the vehicle VH coincide with the target lateral position y may be calculated based on the deviation between the lateral position of the vehicle VH and the target lateral position y, and the present time may be advanced or delayed by the calculated time. The reference point for starting the time measurement may be a timing at which the start condition of the lane change is satisfied (that is, a timing at which the vehicle VH starts the lateral movement), or a timing at which LCA control unit 140 receives LCA request signal.

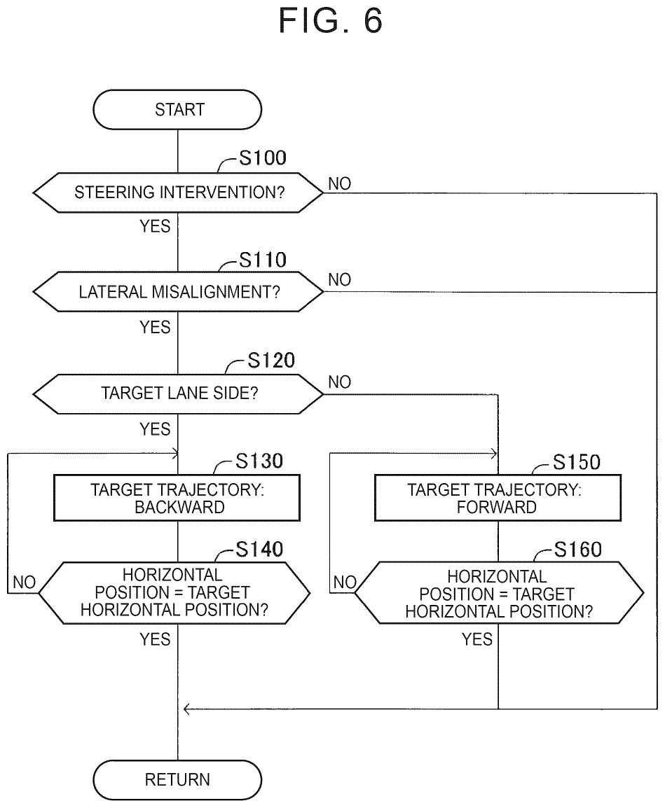

Next, a process of correcting ECU 10 by CPU 11 will be described with reference to FIG. 6. This routine is initiated, for example, when ECU 10 receives a LCA request-signal while ACC and LTA are activated. For the sake of convenience, a case where LCA cancellation conditions (1) to (5) are not satisfied will be described below.

In S100, ECU 10 determines whether or not a steering intervention of the driver is detected based on the detection result of the steering torque sensor 35. If a steering intervention of the driver is detected (Yes), ECU 10 proceeds to S110 process. On the other hand, if the driver's steering intervention is not detected (No), ECU 10 returns this routine.

In S110, ECU 10 determines whether or not there is a deviation between the present lateral position of the vehicle VH and the target trajectory Tt based on the detection result of the external sensor device 40. If there is a deviation between the lateral position of the vehicle VH and the target trajectory Tt (Yes), ECU 10 proceeds to the process of S120. On the other hand, if there is no deviation between the lateral position of the vehicle VH and the target trajectory Tt (No), ECU 10 returns.

In S120, ECU 10 determines whether or not the lateral position of the vehicle VH with respect to the target trajectory Tt is shifted toward the target lane L2 based on the detection result of the external sensor device 40. If the lateral position of the vehicle VH is shifted toward the target lane L2 (Yes), ECU 10 proceeds to S130 process. On the other hand, when the lateral position of the vehicle VH is not shifted toward the target lane L2 (No), that is, when the lateral position is shifted toward the other side than the target lane L2, ECU 10 proceeds to S150 process.

Proceeding from S120 to S130 process, ECU 10 advances the present time of the vehicle VH with respect to the target lane change time LT to slide the target trajectory Tt backward toward the vehicle VH. Then, in S140, ECU 10 determines whether or not the present lateral position of the vehicle VH matches the target lateral position y of the target trajectory Tt at the current time point. If the lateral position of the vehicle VH does not coincide with the target lateral position y (No), ECU 10 returns to S130 process. On the other hand, if the lateral position of the vehicle VH coincides with the target lateral position y (Yes), ECU 10 returns. That is, LCA is restored based on the target trajectory Tt.

Proceeding from S120 to S150 process, ECU 10 delays the present time of the vehicle VH with respect to the target lane change time LT to slide the target trajectory Tt forward away from the vehicle VH. Then, in S160, ECU 10 determines whether or not the present lateral position of the vehicle VH matches the target lateral position y of the target trajectory Tt at the current time point. If the lateral position of the vehicle VH does not coincide with the target lateral position y (No), ECU 10 returns to S150 process. On the other hand, if the lateral position of the vehicle VH coincides with the target lateral position y (Yes), ECU 10 returns. That is, LCA is restored based on the target trajectory Tt.

Although the control device, the control method, and the program of the vehicle according to the present embodiment have been described above, the present disclosure is not limited to the above embodiment, and various modifications can be made without departing from the object of the present disclosure.

For example, in the above-described embodiment, LCA control unit 140 performs LCA based on the target lane change time LT, but may be configured to perform LCA based on the target vehicle speed change distance. In this case, the correction processing unit 150 may perform the correction processing based on the distance instead of the time. The technology of the present disclosure can also be applied to an autonomous vehicle that automatically performs some or all of the driving operations.

What is claimed is:

1. A vehicle control device configured to execute lane change control for automatically changing lanes from a lane where a vehicle is traveling to a target lane adjacent to the lane by causing the vehicle to travel along a set target trajectory, the vehicle control device comprising a correction processing unit configured to, when a lateral position of the vehicle deviates from the target trajectory due to a steering operation of a driver of the vehicle during execution of the lane change control, execute a correction process for moving the target trajectory forward or backward to bring a target lateral position of the target trajectory closer to a current lateral position of the vehicle.

2. The vehicle control device according to claim 1, wherein the correction processing unit is configured to, in execution of the correction process, change a movement amount for moving the target trajectory forward or backward according to an amount of deviation of the lateral position of the vehicle from the target trajectory.

3. The vehicle control device according to claim 1, wherein the correction processing unit is configured to, in execution of the correction process, move the target trajectory backward when the lateral position of the vehicle deviates from the target trajectory toward the target lane, and move the target trajectory forward when the lateral position of the vehicle deviates from the target trajectory to a side opposite to the target lane.

4. A vehicle control method for executing lane change control for automatically changing lanes from a lane where a vehicle is traveling to a target lane adjacent to the lane by causing the vehicle to travel along a set target trajectory, the vehicle control method comprising executing, when a lateral position of the vehicle deviates from the target trajectory due to a steering operation of a driver of the vehicle during execution of the lane change control, a correction process for moving the target trajectory forward or backward to bring a target lateral position of the target trajectory closer to a current lateral position of the vehicle.

5. A non-transitory storage medium storing a program that causes a computer of a vehicle control device to execute a correction process, the vehicle control device being configured to execute lane change control for automatically changing lanes from a lane where a vehicle is traveling to a target lane adjacent to the lane by causing the vehicle to travel along a set target trajectory, the correction process being a process of, when a lateral position of the vehicle deviates from the target trajectory due to a steering operation of a driver of the vehicle during execution of the lane change control, moving the target trajectory forward or backward to bring a target lateral position of the target trajectory closer to a current lateral position of the vehicle.
